(19) United States
(12) Patent Application Publication
(10) Pub. No.: US 2018/0148582 A1
(43) Pub. Date: May 31, 2018

(54) METHOD OF MANUFACTURING SUPER-HYDROPHOBIC AND SUPER-HYDROREPELLENT SURFACE

(71) Applicants: Samsung Electronics Co., Ltd, Gyeonggi-do (KR); Postech Academy-Industry Foundation, Pohang-si (KR)

(72) Inventors: Young Chul Ko, Suwon-si (KR); Sang Joon Lee, Pohang-si (KR); Hyun Joo Kim, Suwon-si (KR); Jeong Eun Ryu, Pohang-si (KR); Ki Woong Kim, Pohang-si (KR)

(21) Appl. No.: 15/827,955

(22) Filed: Nov. 30, 2017

(30) Foreign Application Priority Data
Nov. 30, 2016 (KR) 10-2016-0161859

(51) Int. Cl. C09D 5/16; C09D 127/18; B29C 59/14

(52) U.S. Cl. CPC C09D 5/1681; B29C 59/14; C09D 127/18

(57) ABSTRACT

Provided is a method of manufacturing a super-hydrophobic and super-hydrorepellent surface, and more particularly, a method of manufacturing a super-hydrophobic and super-hydrorepellent surface by plasma treatment. The method includes providing a sample having a surface formed of a polytetrafluoroethylene (PTFE)-based polymer material to a plasma apparatus; injecting oxygen and argon gases into the plasma apparatus; and generating plasma by applying power to the plasma apparatus and plasma-treating the surface of the sample.

### CROSS-REFERENCE TO RELATED APPLICATION(S)

The present application is related to and claims priority to Korean Patent Application No. 10-2016-0161859, filed on Nov. 30, 2016, the disclosure of which is incorporated herein by reference.

### TECHNICAL FIELD

Embodiments of the present disclosure relate to a method of manufacturing a super-hydrophobic and super-hydrorepellent surface, and more particularly, to a method of manufacturing a super-hydrophobic and super-hydrorepellent surface by plasma treatment.

### BACKGROUND

Researches into super-hydrophobic and super-hydrorepellent surfaces have been carried out to prevent water condensation on a surface and easily clean the surface.

Contact angle is a typical indicator of water repellent or super-hydrorepellent properties. In general, a water repellent surface has a contact angle of 110° or greater and a super-hydrorepellent surface has a contact angle of 150° or greater.

As methods for realizing water repellent surfaces, researches have been carried out into a method of coating a polymer having a low surface energy such as a fluorine-substituted polymer or Teflon on a surface of a substrate, a method of forming a micro-nano structure on a surface of a substrate, a method of coating carbon nanotube (CNT) on a surface of a substrate, a method of modifying a surface of a substrate by wet etching, and a method of modifying a surface of a polymer by gas plasma dry etching using fluoroform (CHF₃).

Meanwhile, in recent years, research has also been carried out on the development of a super-hydrophobic surface to realize an anti-icing effect and research has been conducted to prevent condensation by using a liquid film.

However, the above-described various surface modification techniques or surface preparation techniques to obtain the anti-icing effect are limitedly applied due to problems related to authentication of safety and suitability of the surfaces for living bodies, ease and stability of processing, and durability of surfaces with respect to repeated temperature changes and it is difficult to apply these techniques.

### SUMMARY

To address the above-discussed deficiencies, it is a primary object to provide a method of manufacturing a super-hydrophobic and super-hydrorepellent surface by modifying a surface formed of a polytetrafluoroethylene (PTFE)-based polymer material into a super-hydrophobic and super-hydrorepellent surface by plasma treatment.

Additional aspects of the disclosure will be set forth in part in the description which follows and, in part, will be obvious from the description, or may be learned by practice of the disclosure.

One aspect of the present disclosure provides with a method of manufacturing a super-hydrophobic and super-hydrorepellent surface.

The method comprise providing a sample having a surface formed of a polytetrafluoroethylene (PTFE)-based polymer material to a plasma apparatus; injecting oxygen and argon gases into the plasma apparatus; and generating plasma by applying power to the plasma apparatus and plasma-treating the surface of the sample.

The sample may comprise at least one of a substrate in which a PTFE-based polymer material is molded into a flat plate shape, a substrate in which a PTFE-based polymer material has a curved surface, a substrate in which a PTFE-based polymer material is coated on a surface of a metallic material, and a substrate in which a PTFE-based polymer material is coated on a surface of an organic/inorganic polymer material in the providing of the sample having the surface formed of the PTFE-based polymer material to the plasma apparatus.

The generating of plasma by applying power to the plasma apparatus and the plasma-treating of the surface of the sample may comprise applying a power of 100 to 1000 W to the power the plasma apparatus.

The generating of plasma by applying power to the plasma apparatus and the plasma-treating of the surface of the sample may comprise plasma-treating the surface of the sample for 30 minutes to 5 hours.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a conceptual diagram illustrating a plasma apparatus 100;

FIG. 2 is a flowchart for describing a method of manufacturing a super-hydrophobic and super-hydrorepellent surface according to an embodiment;

FIG. 3 is a diagram illustrating an exemplary method of manufacturing a super-hydrophobic and super-hydrorepellent surface;

FIG. 4 is a diagram illustrating another exemplary method of manufacturing a super-hydrophobic and super-hydrorepellent surface;

FIGS. 5, 6, 7 and 8 are graphs illustrating the results of analyzing the effects of each of the four main factors on the manufacture of the super-hydrophobic surfaces after performing experiments in which 4 main factors were combined according to the Taguchi method;

FIG. 9 is a graph illustrating surface contact angles with respect to the RF power;

FIGS. 10, 11, 12, 13A, 13B, 13C, 13D and 14 illustrate images of a PTFE substrate before and after plasma treatment;

FIG. 15 is a view illustrating a contact angle of the bare-PTFE substrate before the plasma treatment process;

FIG. 16 is a view illustrating a contact angle of the PTFE substrate after the plasma treatment process; and

FIG. 17 is a view illustrating a sliding angle of the PTFE substrate after the plasma treatment process.

### DETAILED DESCRIPTION

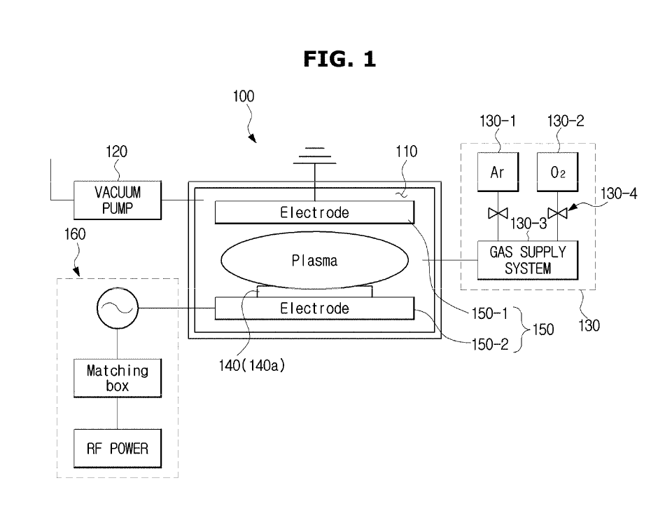

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Reference will now be made in detail to the embodiments of the present disclosure, examples of which are illustrated in the accompanying drawings, wherein like reference numerals refer to like elements throughout. This specification does not describe all elements of the embodiments of the present disclosure and detailed descriptions on what are well known in the art or redundant descriptions on substantially the same configurations may be omitted.

Also, it is to be understood that the terms “include” or “have” are intended to indicate the existence of elements disclosed in the specification, and are not intended to preclude the possibility that one or more other elements may exist or may be added.

In this specification, terms “first,” “second,” etc. are used to distinguish one component from other components and, therefore, the components are not limited by the terms.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Embodiments of the present disclosure relate to a method of manufacturing a super-hydrophobic and super-hydrorepellent surface, and more particularly, to a method of manufacturing a super-hydrophobic and super-hydrorepellent surface by plasma-treating a surface of a hydrophobic polymer material to realize the super-hydrophobic and super-hydrorepellent surface.

The method of manufacturing a super-hydrophobic and super-hydrorepellent surface according to an embodiment may be used to modify a surface of a material applied to various electronic appliances or industrial goods into a super-hydrophobic and super-hydrorepellent surface.

For example, a material having a super-hydrophobic and super-hydrorepellent surface prepared by the method according to the present disclosure may be applied to a bell mouth of a fan in a refrigerator, a heat exchanger of a refrigerator, an ice maker of a refrigerator, a drain structure of a refrigerator, a washing machine, a dish washer, a membrane filter of a water purifier for water purification, a display device such as a smart phone or a tablet PC, a solar cell, and the like. However, these are only application examples to which the material having a super-hydrophobic and super-hydrorepellent surface prepared according to an embodiment is applicable and the application examples are not limited thereto.

Hereinafter, operating principles and embodiments of the present disclosure will be described with reference to the accompanying drawings.

The present disclosure is characterized in realizing a super-hydrophobic and super-hydrorepellent surface by plasma-treating a surface of a substrate. More particularly, the surface of the substrate is modified to a super-hydrophobic and super-hydrorepellent surface by adjusting exposure time to plasma, types of reaction gases, ratio between the reaction gases, etching pressure, and power source as energy to generate plasma.

Thus, a structure of a plasma apparatus configured to modify a surface of a substrate will be described, and then a method of manufacturing a super-hydrophobic and super-hydrorepellent surface according to an embodiment will be described for enhancement of understanding of the invention.

FIG. 1 is a conceptual diagram illustrating a plasma apparatus 100.

Referring to FIG. 1, the plasma apparatus 100 according to an embodiment includes a vacuum chamber 110, a vacuum pump 120, a gas supply system 130, a target of plasma treatment 140, an electrode 150, and a power supply 160.

The vacuum pump 120 is provided at one side of the vacuum chamber 110 to maintain a vacuum state of the vacuum chamber 110.

The gas supply system 130 may be provided at a side wall of the vacuum chamber 110 and supply gas into the vacuum chamber 110.

The gas supply system 130 may include a first gas chamber 130-1, a second gas chamber 130-2, a gas volume controller 130-3 configured to connect the vacuum chamber 110 to the first and second gas chambers 130-1 and 130-2, and control valves 130-4 configured to control flow rates of gases introduced into the vacuum chamber 110 from the first and second gas chambers 130-1 and 130-2.

Argon gas may be stored in the first gas chamber 130-1 and oxygen gas may be stored in the second gas chamber 130-2.

The target of plasma treatment 140 may be fixed to one surface of the electrode 150. In the present disclosure, the target of plasma treatment 140 is a sample 140a having a surface formed of a polytetrafluoroethylene (PTFE)-based polymer material. The sample 140a may be provided in the form of a sheet or in a molded form having a curved shape according to another embodiment.

In addition, the sample 140a may be provided in a form prepared by coating a PTFE-based polymer material on the surface of a metallic material or another polymer material. In this regard, the polymer material on which the PTFE-based polymer material is coated may be an organic or inorganic polymer material, but types thereof are not particularly limited.

The electrode 150 includes an upper electrode 150-1 and a lower electrode 150-2. Here, the lower electrode 150-2 is connected to the power supply 160. When a power supply supplies power to the lower electrode 150-2, an electric field is generated and discharging is initiated, thereby generating plasma.

The configuration of the plasma apparatus 100 has been described above.

Hereinafter, a method of manufacturing a super-hydrophobic and super-hydrorepellent surface will be described.

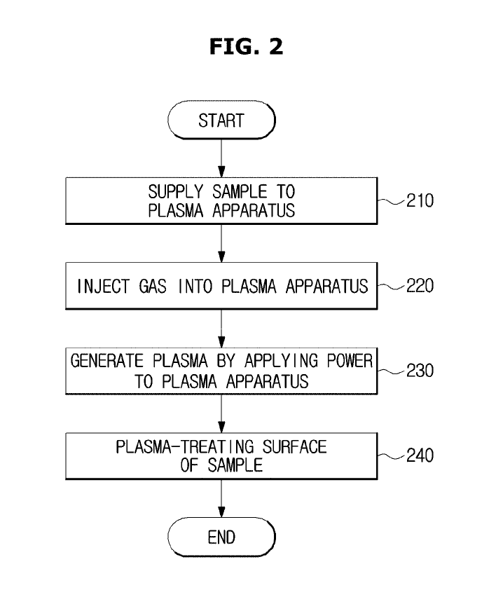

FIG. 2 is a flowchart for describing a method of manufacturing a super-hydrophobic and super-hydrorepellent surface according to an embodiment.

Referring to FIG. 2, the method of manufacturing the super-hydrophobic and super-hydrorepellent surface includes providing a sample having a surface formed of a PTFE-based polymer material to a plasma apparatus (210), injecting oxygen and argon gases into the plasma apparatus (220), generating plasma by applying power to the plasma apparatus (230), and plasma-treating the surface of the sample (240).

First, the same having the surface formed of the PTFE-based polymer material is provided to the plasma apparatus.

The PTFE-based polymer material surface has non-sticking properties to which most substances do not stick and may be represented by Structural Formula 1 below.

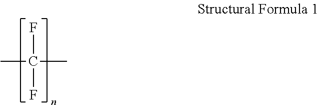

PTFE may be used in a temperature range of −260° C. to 260° C. and has stable heat resistance even up to 300° C. in short-term use. In addition, PTFE that is stable against chemical products is a certified material applicable to surfaces of refrigerators in terms of safety as a material having chemical resistance not allowing penetration of chemicals thereinto. Since fluorine groups (—CF₂—) are basically distributed on the surface of PTFE, PTFE has a non-wetting (hydrophobic) property which is low in surface energy and does not get wet with water.

The sample used in the present disclosure may include at least one of a substrate in which a PTFE-based polymer material is molded into a flat plate shape, a substrate in which a PTFE-based polymer material has a curved surface, a substrate in which a PTFE-based polymer material is coated on a surface of a metallic material, and a substrate in which a PTFE-based polymer material is coated on a surface of an organic/inorganic polymer material. However, the structure of the sample is not limited thereto. Throughout the specification, a sample having a PTFE-based polymer material surface may be referred to as a PTFE substrate for descriptive convenience.

Next, the operation of injecting oxygen and argon gases into the plasma apparatus and the operation of generating plasma by applying power to the plasma apparatus and plasma-treating the surface of the sample may be performed.

According to the embodiment, the surface of the PTFE substrate was provided to the plasma treatment process by optimizing a total gas flow, a flow rate ratio of Ar and O₂ ([Ar]:[O₂]), an RF power, and an exposure time to plasma during the plasma treatment process.

More particularly, the power supply may supply a power of 100 to 1000 W for 30 minutes to 5 hours during the plasma treatment process. Meanwhile, the total gas flow, the flow rate ratio of Ar and O₂, and the like applied during the plasma treatment process will be described in detail with descriptions of experimental examples below.

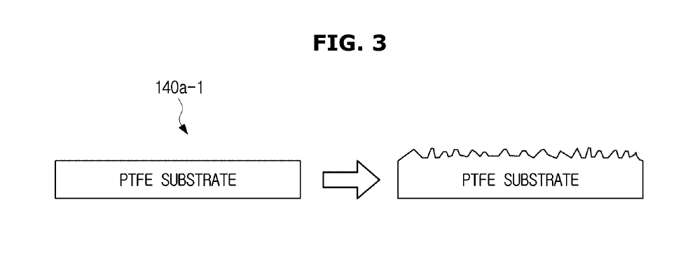

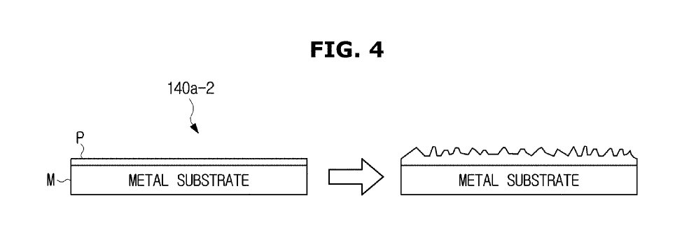

The method of realizing the super-hydrophobic and super-hydrorepellent surface described above may be summarized in FIGS. 3 and 4 below.

FIG. 3 is a diagram illustrating an exemplary method of manufacturing a super-hydrophobic and super-hydrorepellent surface. FIG. 4 is a diagram illustrating another exemplary method of manufacturing a super-hydrophobic and super-hydrorepellent surface.

Referring to FIG. 3, the sample 140a-1 according to the embodiment may be provided in the form of a flat plate molded using a PTFE-based polymer material. When the sample 140a-1 is provided to the plasma apparatus, a mixed gas of argon and oxygen is injected into a vacuum chamber of the plasma apparatus and the surface of the sample is modified into a super-hydrophobic and super-hydrorepellent surface by applying AC power thereto.

The method of manufacturing the super-hydrophobic and super-hydrorepellent surface illustrated in FIG. 4 is the same as that illustrated in FIG. 3 except that a sample 140a-2 is provided in a form prepared by coating a PTFE-based polymer material P on the surface of a metal substrate M. Hereinafter, descriptions given above with reference to FIG. 3 will not be repeated.

Next, an experimental example to optimize processing conditions for manufacturing a super-hydrophobic and super-hydrorepellent surface according to the present embodiment will be described for enhancement of understanding of the invention.

According to the present embodiment, experiments were performed 9 times based on Table 1 below after setting the total gas flow, flow rate ratio of Ar and O₂ ([Ar]:[O₂]), RF power, and exposure time, which are variables of the process of manufacturing the super-hydrophobic and super-hydrorepellent surface, as main factors according to the Taguchi technique.

TABLE 1

| | Level 1 | Level 2 | Level 3 |
|---|---|---|---|
| Total gas flow (sccm) | 16 | 32 | 48 |
| Gas flow rate [Ar]:[O₂] | 5:1 | 5:3 | 5:5 |
| RF power (W) | 50 | 10 | 200 |
| Exposure time (min) | 20 | 60 | 180 |

The total gas flows were set to 16 sccm, 32 sccm, and 48 sccm, respectively, and the flow rate ratios of Ar and O₂ ([Ar]:[O₂]) were set to 5:1, 5:3 and 5:5, respectively.

Meanwhile, since temperature inside the vacuum chamber of the plasma apparatus increases with the increase of the RF power and the exposure time, surface treatment conditions were set such that a maximum temperature inside the vacuum chamber does not exceed 200° C.

RF powers of 50 W, 100 W, and 200 W were supplied and the exposure time was set such that the samples were exposed to plasma for 20 minutes, 60 minutes, and 180 minutes, respectively.

Three PTFE samples were subjected to surface treatment respectively under 9 conditions shown in Table 2 below. Contact angles were measured 5 times for each sample and average values thereof were analyzed. The results are shown in Table 2 below.

TABLE 2

| | Total | Flow rate | RF | Exposure | Average |
|---|---|---|---|---|---|
| No. | gas flow | ratio | power | time | contact angle |
| (Exp. #) | (sccm) | [Ar]:[O₂] | (W) | (min) | (°) |
| 1 | 16 | 13.3:2.7 | 50 | 20 | 122.22 |
| 2 | 16 | 10:6 | 100 | 60 | 157.69 |
| 3 | 16 | 8:8 | 200 | 180 | 164.21 |
| 4 | 32 | 26.7:5.3 | 100 | 180 | 160.39 |
| 5 | 32 | 20:12 | 200 | 20 | 158.83 |
| 6 | 32 | 16:16 | 50 | 60 | 122.55 |
| 7 | 48 | 40:8 | 200 | 60 | 148.27 |
| 8 | 48 | 30:18 | 50 | 180 | 132.95 |
| 9 | 48 | 24:24 | 100 | 20 | 132.28 |

Referring to Table 2, among the 9 experimental conditions, it was confirmed that surfaces having an average contact angle of 150° or greater were obtained in the case of Exp. #2 in which plasma treatment was performed under conditions of the total gas flow of 16 sccm, the Ar and O₂ flow rate ratio of 5:3, and the RF power of 100 W, and the exposure time of 60 minutes, in the case of Exp. #3 in which plasma treatment was performed under conditions of the same total gas flow as that of Exp. #2, the Ar and O₂ flow rate ratio of 1:1, the RF power of 200 W, and the exposure time of 180 minutes, and in the cases of Exp. #4 and Exp. #5 in which the doubled total gas flow of 32 sccm, the Ar and O₂ flow rate ratios of 5:1 and 5:3, the RF powers of 200 W and 100 W, and the exposure times of 180 minutes and 20 minutes.

Although the PTFE surface has an average sliding angle of 10° or greater before the plasma treatment, the average sliding angles of the PTFE surfaces of Exp. #2 and Exp. #3 having greater contact angles decrease to about 6° by the plasma treatment and a surface having a sliding angle of 1° or less was also obtained.

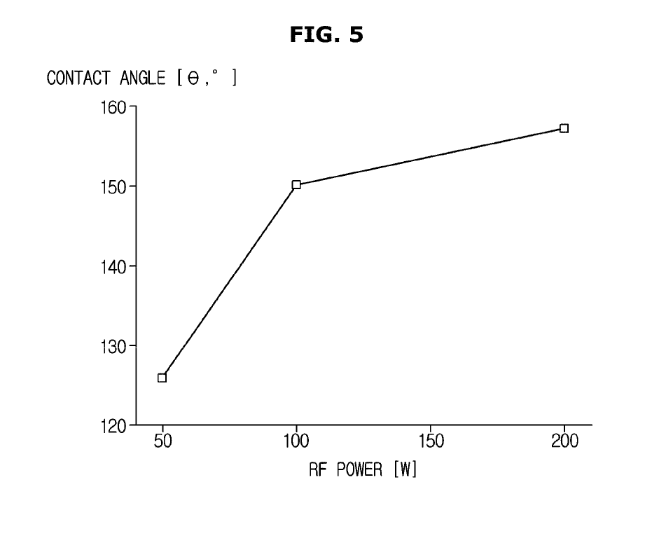

FIGS. 5 to 8 are graphs illustrating the results of analyzing the effects of each of the four main factors on the manufacture of the super-hydrophobic surfaces after performing experiments in which 4 main factors were combined according to the Taguchi method. S/N ratios for each of the factors was calculated for each level and differences in contact angles according to the levels were compared with each other.

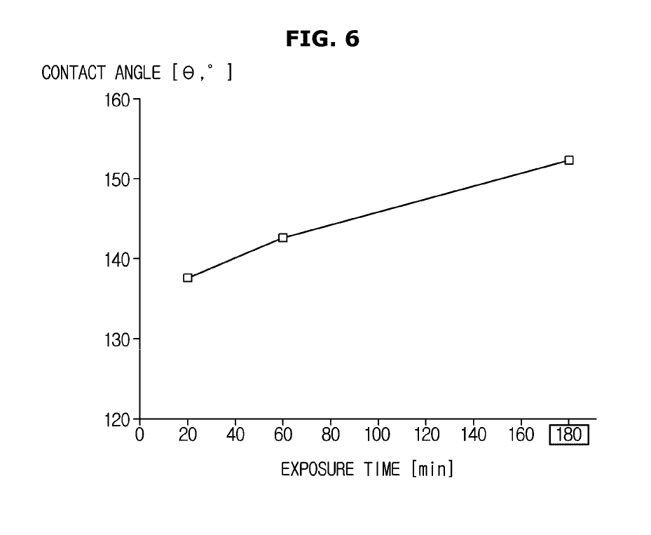

Referring to FIGS. 5 and 6, it was confirmed that the greatest difference was observed between levels in the RF power factor and the second greatest difference was observed between levels in the exposure time factor.

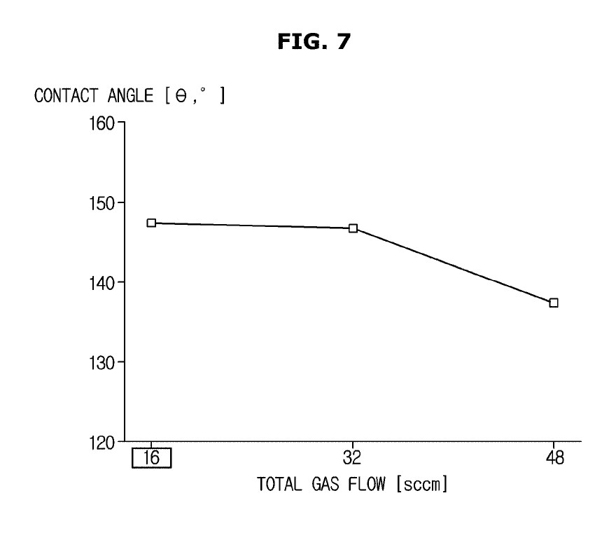

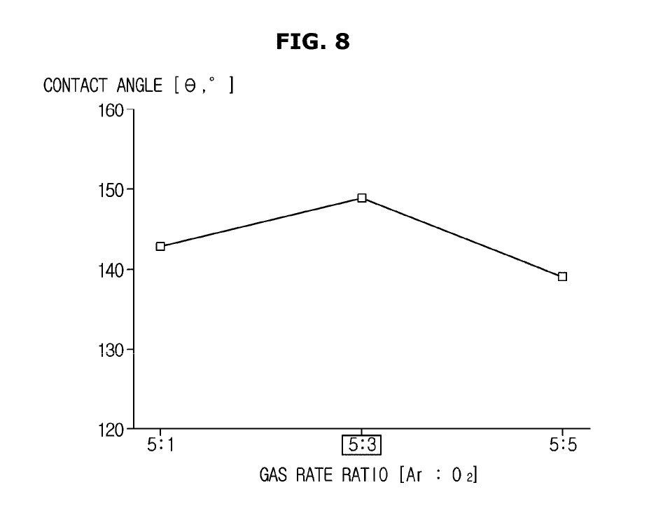

Referring to FIGS. 7 and 8, it was confirmed that small differences were observed between levels in the total gas flow factor and the Ar and O₂ flow rate ratio factor.

As a result of the analysis according to the Taguchi method, excellent contact angle properties were obtained when the total gas flow was 16 sccm and the flow rate ratio of Ar and O₂ was 5:3.

The RF power factor, which was concluded as the most important factor, was divided into more levels and experiments were further performed to find optimum conditions therefor. The results are shown in Table 3 below.

TABLE 3

| | Total | Flow rate | RF | Exposure | Average |
|---|---|---|---|---|---|
| No. | gas flow | ratio | power | time | contact angle |
| (Exp. #) | (sccm) | [Ar]:[O₂] | (W) | (min) | (°) |
| 10 | 16 | 10:6 | 50 | 180 | 121.7 |
| 11 | 16 | 10:6 | 70 | 180 | 142.5 |
| 12 | 16 | 10:6 | 90 | 180 | 147.0 |
| 13 | 16 | 10:6 | 100 | 180 | 158.5 |
| 14 | 16 | 10:6 | 150 | 180 | 165.9 |
| 15 | 16 | 10:6 | 200 | 180 | 166.0 |

In the above experiments, the other three factors except for the RF power were controlled under the same conditions. That is, in the case where the total gas flow was maintained at 16 sccm and the Ar and O₂ flow rate ratio was constantly maintained at 5:3, the surfaces were plasma-treated at different RF powers of 50 W, 70 W, 90 W, 100 W, 150 W, and 200 W for 180 minutes.

In the same manner as the previous experiments according to the Taguchi method, 3 samples were processed for each experimental condition and contact angles were measured 5 times for each sample.

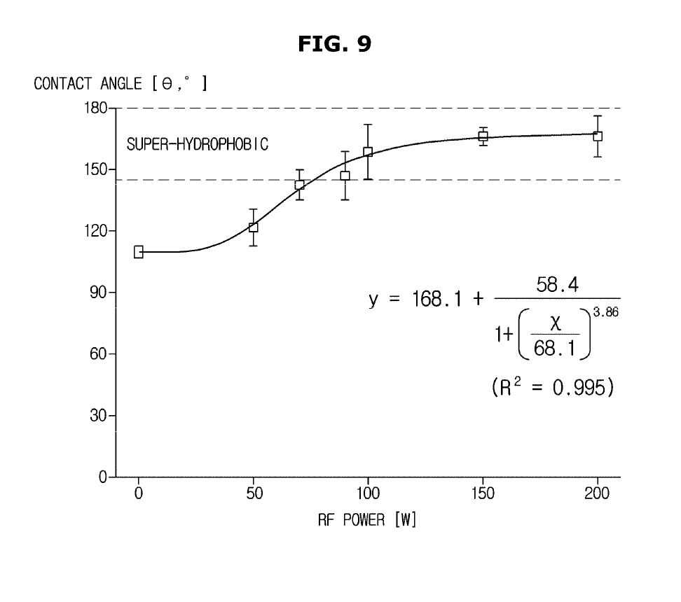

FIG. 9 is a graph illustrating surface contact angles with respect to the RF power.

As illustrated in FIG. 9, it was confirmed that a super-hydrophobic and super-hydrorepellent surface having a contact angle of 150° or greater was manufactured when the RF power is 100 W or higher. In particular, under the conditions of 150 W and 200 W or greater, it was confirmed that excellent super-hydrophobic wetting properties enough to make it impossible to fix a droplet having a volume of 5 μl to the prepared super-hydrophobic surface were obtained.

As a result of optimization of the plasma treatment process to obtain the super-hydrophobic surface as described above, it was confirmed that an excellent super-hydrophobic and super-hydrorepellent surface was obtained by processing the plasma treatment at the RF power of 150 W for 3 hours while controlling the total gas flow of reactive gases at 16 sccm and the flow rate ratio of Ar and O₂ at 10:6.

Next, the results of observation of the shapes of the super-hydrophobic and super-hydrorepellent surfaces prepared according to the experiments described above will be described in detail for enhancement of understanding of the invention.

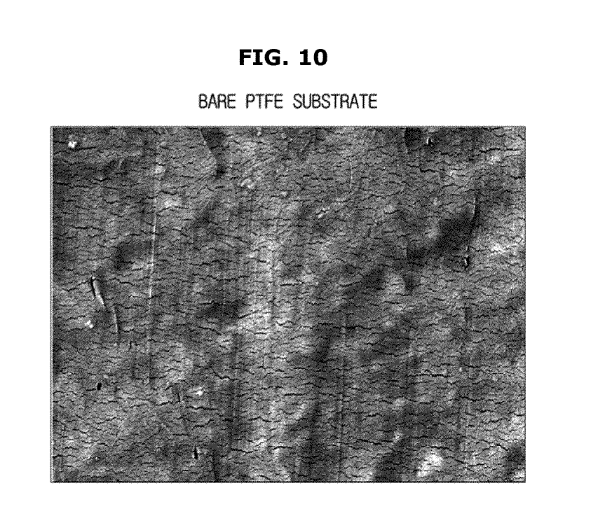

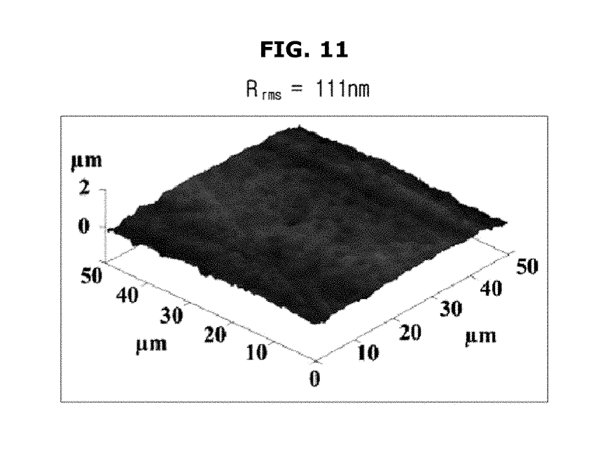

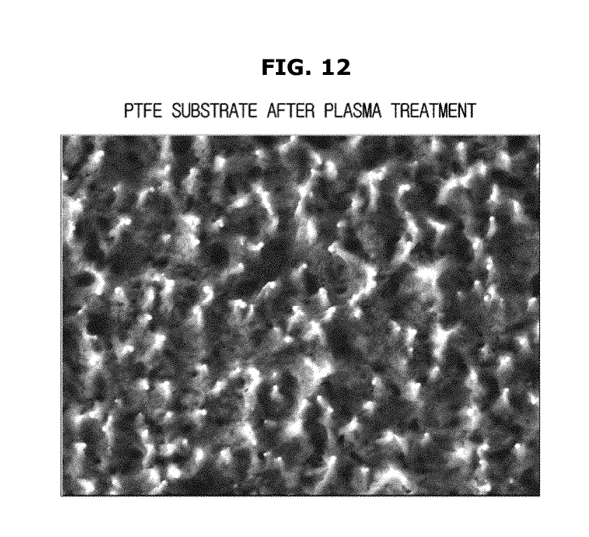

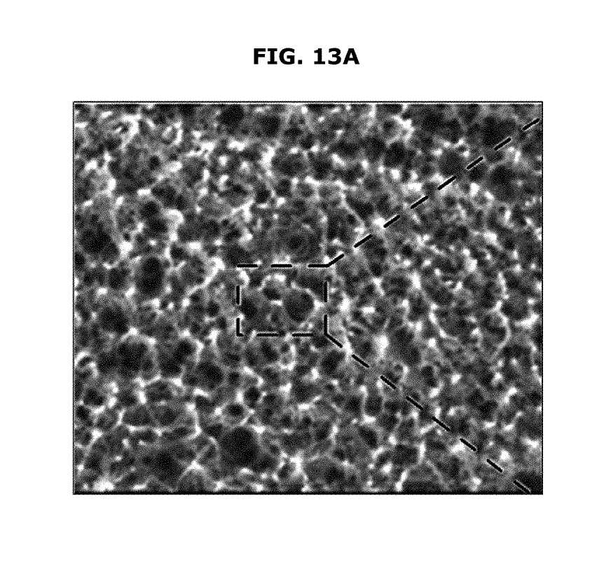

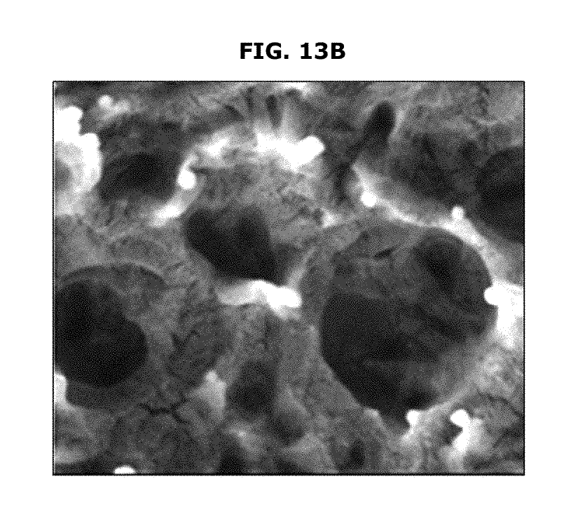

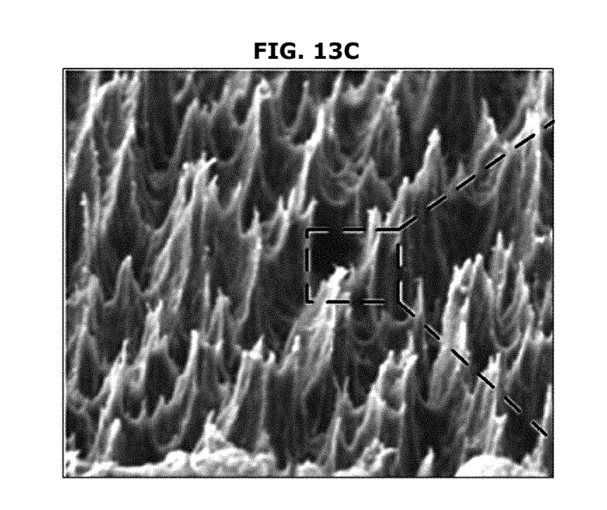

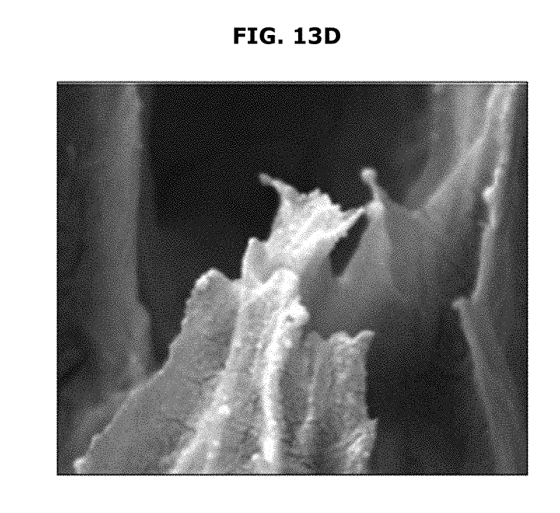

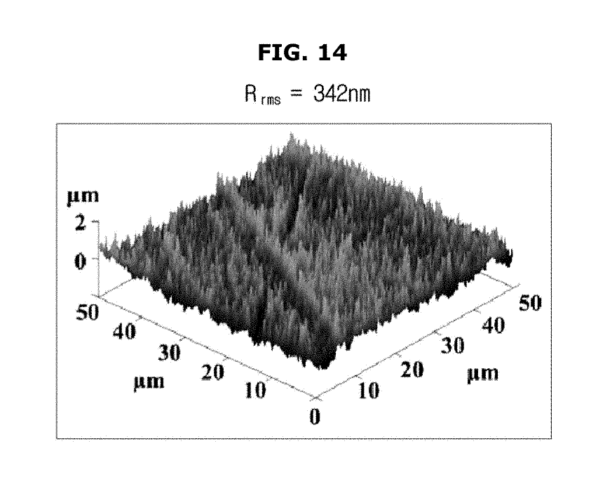

FIGS. 10 to 14 illustrate images of a PTFE substrate before and after plasma treatment. More particularly, FIG. 10 is a scanning electron microscopy (SEM) image of a surface of a bare-PTFE substrate before the plasma treatment. FIG. 11 is an atomic force microscopy (AFM) image of the surface of the bare-PTFE substrate before the plasma treatment. FIGS. 12 and 13 are SEM images of the surface of the PTFE substrate after the plasma treatment. FIG. 14 is an AFM image of the surface of the PTFE substrate after the plasma treatment.

Referring to FIGS. 10 and 11, an average roughness (Rᵣₘₛ) of the surface of the bare-PTFE substrate was about 111 nm, and thus it was confirmed that the bare PTFE substrate had a smooth surface. On the contrary, it was confirmed that the average roughness (Rᵣₘₛ) of the surface of the PTFE substrate increased to about 343 m after plasma-treating the bare PTFE substrate as illustrated in FIGS. 12 to 14. More particularly, referring to FIGS. 13A-13D, it was confirmed that hundreds of nano-size sharp protrusions were uniformly formed on the surface of the prepared super-hydrophobic super-hydrorepellent PTFE substrate (FIG. 13A, FIG. 13C, and FIG. 13D) and a characteristic structure having hollows and spherical shapes on top of the protrusions was formed (FIG. 13B).

As a result of the experiments, it was confirmed that the PTFE substrate had a higher surface roughness by plasma-treating the surface of the PTFE substrate, and thus the PTFE substrate had super-hydrophobic and super-hydrorepellent properties.

Since a plasma-treated surface of a material according to the disclosed embodiments has super-hydrophobic and super-hydrorepellent properties as described above, the material may be provided to a process of mass production of structures requiring stable operation against temperature changes and surfaces of various products requiring anti-fouling effects. In this case, anti-icing and anti-fouling performance may be improved on the surfaces of the products and stability and efficiency of the products may also be enhanced.

Hereinafter, performances of plasma-treated surfaces according to the present disclosure were compared with each other and analyzed and the results will be described.

For comparison between the plasma-treated PTFE substrate according to the present disclosure and the bare PTFE substrate before the plasma treatment process, static contact angles (Θ) and sliding angles (α) were measured before and after the plasma treatment process of the PTFE substrate and the results are shown in Table 4 below.

TABLE 4

| | |
|---|---|
| | PTFE substrate after plasma |
| Bare-PTFE substrate | treatment process |

| Contact angle | Sliding angle | Contact angle | Sliding angle |
|---|---|---|---|
| (Θ1) | (α1) | (Θ2) | (α2) |
| 111.0° ± 2.5° | <40° | 171.4° ± 3.3° | <1° |

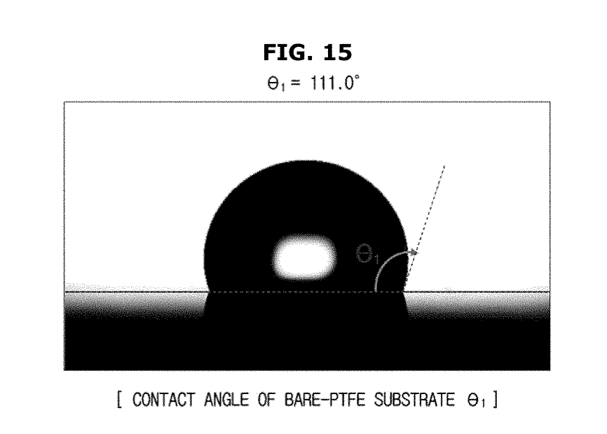

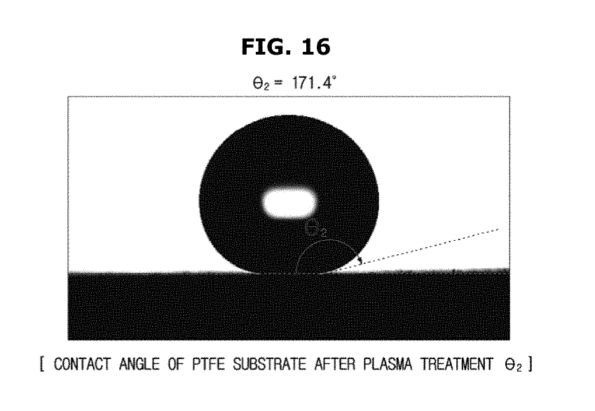

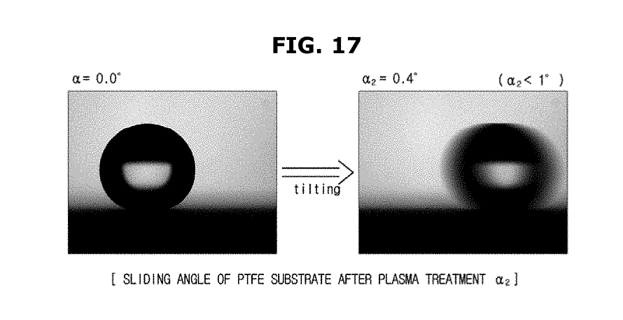

FIG. 15 is a view illustrating a contact angle of the bare-PTFE substrate before the plasma treatment process. FIG. 16 is a view illustrating a contact angle of the PTFE substrate after the plasma treatment process. FIG. 17 is a view illustrating a sliding angle of the PTFE substrate after the plasma treatment process.

Referring to Table 4 and FIGS. 15 and 16, it was confirmed that while a contact angle (Θ₁) of the bare-PTFE substrate before the plasma treatment process was 111.0°±2.5°, a contact angle (Θ₂) of the PTFE substrate after the plasma treatment process was 171.4°±3.3°.

In other words, it was confirmed that the contact angle (Θ₂) of the PTFE substrate etched according to the present embodiment increased from the contact angle (Θ₁ᵢ) of the not etched bare-PTFE substrate by 60.4° on average.

Also, referring to Table 4 and FIG. 17, it was confirmed that while a sliding angle (α₁) of the bare-PTFE substrate before the plasma treatment process was about 40°, a sliding angle (α₂) of the PTFE substrate after the plasma treatment process was about 0.4° close to about 1°.

Thus, it was confirmed that by changing surface wettability of a PTFE-based material by plasma-treating the PTFE-based material, super-hydrophobic and super-hydrorepellent properties may be applied to the surface.

As is apparent from the above description, according to the method of manufacturing the super-hydrophobic and super-hydrorepellent surface according to the present disclosure, a surface having durability against repeated temperature changing cycles may be realized with ease and safety of the surface treatment process.

In addition, anti-icing and anti-fouling properties may be provided to surfaces of various electronic appliances or industrial goods and thus performance and operation efficiencies of products may be improved.

Also, the method may be applied to mass production of various electronic appliances or industrial goods and the super-hydrophobic and super-hydrorepellent surface may be realized in safe and economical methods.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of manufacturing a super-hydrophobic and super-hydrorepellent surface, the method comprising:
providing a sample having a surface formed of a polytetrafluoroethylene (PTFE)-based polymer material to a plasma apparatus;
injecting oxygen and argon gases into the plasma apparatus; and
generating plasma by applying power to the plasma apparatus and plasma-treating the surface of the sample.

2. The method according to claim 1, wherein in the providing of the sample having the surface formed of the PTFE-based polymer material to the plasma apparatus, the sample comprises at least one of a substrate in which a PTFE-based polymer material is molded into a flat plate shape, a substrate in which a PTFE-based polymer material has a curved surface, a substrate in which a PTFE-based polymer material is coated on a surface of a metallic material, and a substrate in which a PTFE-based polymer material is coated on a surface of an organic/inorganic polymer material.

3. The method according to claim 1, wherein the generating of the plasma by applying power to the plasma apparatus and the plasma-treating of the surface of the sample comprises applying a power of 100 W to 1000 W to the plasma apparatus.

4. The method according to claim 1, wherein the generating of the plasma by applying power to the plasma apparatus and the plasma-treating of the surface of the sample comprises plasma-treating the surface of the sample for 30 minutes to 5 hours.
